(19) United States
(12) Patent Application Publication
(10) Pub. No.: US 2026/0070264 A1
(43) Pub. Date: Mar. 12, 2026

(54) Method and System for Manufacturing High-Density Foam

(71) Applicant: WILLIE KAIPING HUANG, TAIPEI (TW)

(72) Inventor: WILLIE KAIPING HUANG, TAIPEI (TW)

(21) Appl. No.: 18/830,168

(22) Filed: Sep. 10, 2024

(51) Int. Cl. B29B 17/00; B29B 17/04; B29K 105/04; B29K 105/26

(52) U.S. Cl. CPC B29B 17/0042; B29B 17/0412; B29B 2017/042; B29K 2105/04; B29K 2105/26; B29K 2995/0063

(57) ABSTRACT

A method and a system for manufacturing a high-density foam are provided, which mainly shred a plurality of waste foam scraps with different shapes and sizes and a density of 40-60 g/cm³ into shattered foams, and transfer the shattered foams into a mixing drum and spray a glue into the mixing drum to mix with the shattered foams, and subsequently transfer to a mold bucket. After 90-120 minutes, a high-density foam is naturally formed under the condition of 60-100% humidity and room temperature of 10-40 degree C., and then removed from the mold bucket to be cut.

### BACKGROUND OF THE INVENTION

### Field of the Invention

The present invention relates to a method and a system for manufacturing a high-density foam, and particularly an environmental-friendly method and system which could make the high-density foam by simple manufacturing processes.

### Description of the Related Art

Foam is a high molecular weight polyurethane, and the amine ester contained in its main chain is a characteristic feature thereof. This high molecular weight material is widely used in industry and daily life. In the field of daily life, polyurethane is used to make various kinds of plastic sponges, and the product is characterized by various advantages of independent bubble structure, low density, good flexibility, low thermal conductivity, moisture absorption and breathability, good impermeability, ease of processing, easy associativity with other materials, heat preservation and insulation, sound insulation, vibration proof, strong coloring, resiliency, excellent corrosion resistance, resistance to high and low temperature changes, weather resistance, aging resistance, and so on. Since the foam has the advantages of resiliency, lightweight, etc., it can be widely applied in transportation, furniture, packaging, textiles, insulation materials, exercise equipment, footwear, freezer storage containers and pipeline insulation, and so on. In response to the needs of different applications, we have also developed various functional foams, such as conductive foam, sound-absorbing foam, anti-static foam, and fire-resistant foam.

With the growing awareness of environmental protection, many products in society are easy to cause environmental pollution problems after disposal and are thus often recycled, such as foam. Foam incineration is prone to produce poisonous gas, and foam is also nonperishable if landfilled. But foam has quite a wide range of uses after recycling, and is more cost-effective than manufacturing from raw materials. For example, recycled foam can be made into carpet accessories, and also can be made into soft fillings to replace the materials installed inside a furniture, such as spring mattresses and sofas. When making other foam products with new foam, the foam wastes/corner waste materials produced during the cutting process of new foam could even have a considerable usability and economic value.

### SUMMARY OF THE INVENTION

Accordingly, based on the reasons above, the inventors are still diligent in developing and researching, and keep testing and accumulating experience, and finally gain a creation that can solve the above drawbacks.

The main objective of the present invention is to provide a method and a system for manufacturing a high-density foam, and the manufacturing process of the method and the system is simple and environmental-friendly.

In order to attain the objective above, the method for manufacturing a high-density foam of the present invention comprises following steps:
step a: taking a plurality of waste foam scraps with different shapes and sizes and a density of 40˜60 g/cm³;
step b: shredding the waste foam scraps into shattered foams;
step c: taking a predetermined weight of the shattered foams and transferring into a mixing drum;
step d: spraying a glue into the mixing drum to mix with the shattered foams inside the mixing drum, wherein the glue at least contains 20-50% alcohol and 20-50% dichloromethane;
step e: stirring for 15-30 minutes and transferring to a mold bucket;
step f: compressing the shattered foams in the mold bucket;
step g: under the condition of 60-100% humidity and room temperature of 10-40 degree Celsius, naturally forming a high-density foam after 90-120 minutes;
step h: removing the high-density foam from the mold bucket and cutting it.

In one implementation, the shattered foams in step b is shredded by a shredder.

In one implementation, the shattered foams in the mold bucket in step f are compressed by a steel plate which is lowered by a hydraulic cylinder.

In order to attain the objective above, the system for manufacturing a high-density foam of the present invention comprises a shredder, a mixing drum, a glue spraying device, a mold bucket, a pressure device, and a cutting device, wherein the shredder is used for shredding a plurality of waste foam scraps with different shapes and sizes and a density of 40˜60 g/cm³ into shattered foams. The mixing drum is connected to the shredder for receiving the shattered foams after shredding. The glue spraying device is used for spraying a glue into the mixing drum to mix the shattered foams in the mixing drum with the glue. The mold bucket is connected to the mixing drum for receiving the shattered foams after mixing with the glue evenly. The pressure device is used for compress the shattered foams in the mold bucket. And the cutting device is used for receiving the high-density foam formed after being compressed by the pressure device and removed from the mold bucket, and cuts the high-density foam into a predetermined shape or size.

In one implementation, the shattered foams are weighed and then transferred to the mixing drum.

In one implementation, the glue at least contains 20-50% alcohol and 20-50% dichloromethane.

In one implementation, the pressure device comprises a steel plate and a hydraulic cylinder for pushing the steel plate down to compress the shattered foams in the mold bucket.

The invention will become better understood with regard to the following detailed description of the preferred but non-limiting embodiments. The following description is made with reference to the accompanying drawings and denotations to describe specific content and expected results of the present invention.

### BRIEF DESCRIPTION OF THE DRAWINGS

FIG. 1 is a flow diagram illustrating a method for manufacturing a high-density foam of an embodiment of the present invention.

FIG. 2 is an architecture diagram illustrating a system for manufacturing a high-density foam of an embodiment of the present invention.

### DETAILED DESCRIPTION OF THE INVENTION

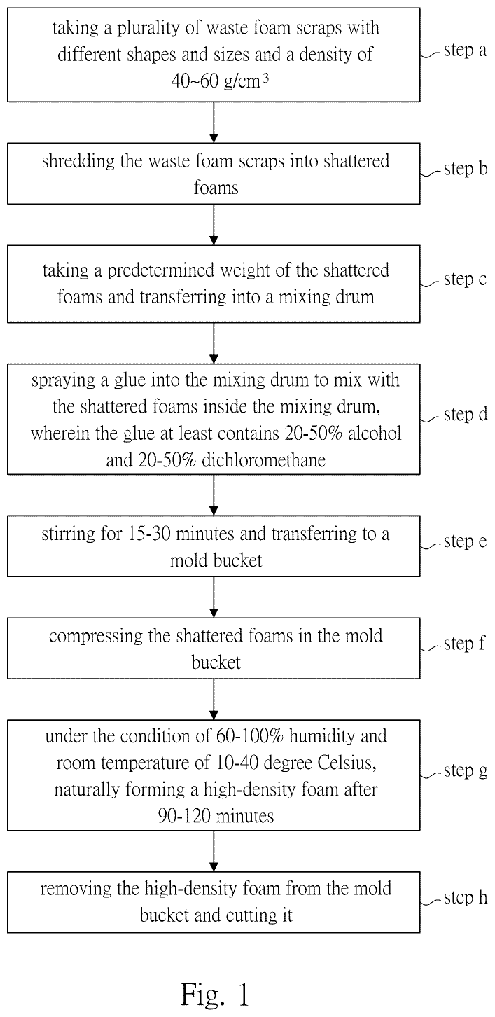

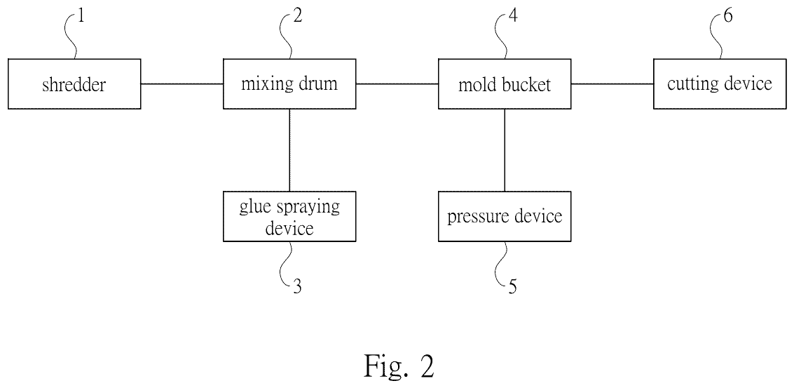

Please refer to FIG. 1 and FIG. 2, which shows a preferred embodiment of a method and a system for manufacturing a high-density foam, respectively.

The method for manufacturing a high-density foam of the present invention comprises following steps:
step a: taking a plurality of waste foam scraps with different shapes and sizes and a density of 40˜60 g/cm³;
step b: shredding the waste foam scraps into shattered foams;
step c: taking a predetermined weight of the shattered foams and transferring into a mixing drum;
step d: spraying a glue into the mixing drum to mix with the shattered foams inside the mixing drum, wherein the glue at least contains 20-50% alcohol and 20-50% dichloromethane;
step e: stirring for 15-30 minutes and transferring to a mold bucket;
step f: compressing the shattered foams in the mold bucket;
step g: under the condition of 60-100% humidity and room temperature of 10-40 degree Celsius, naturally forming a high-density foam after 90-120 minutes;
step h: removing the high-density foam from the mold bucket and cutting it.

As shown in FIG. 2, the present invention could provide a system for manufacturing a high-density foam for the manufacturing process above. The system comprises a shredder 1, a mixing drum 2, a glue spraying device 3, a mold bucket 4, a pressure device 5, and a cutting device 6.

The shredder 1 is used for shredding a plurality of waste foam scraps with different shapes and sizes into shattered foams, and the density of the waste foam scraps is approximately 40˜60 g/cm³. The mixing drum 2 is connected to the shredder 1 for receiving the shattered foams after shredding, and the shattered foams are weighed and then transferred to the mixing drum 2.

The glue spraying device 3 is used for spraying a glue into the mixing drum 2, so as to mix the shattered foams in the mixing drum 2 with the glue. The mold bucket 4 is connected to the mixing drum 2 for receiving the shattered foams which have been mixed with the glue evenly.

The pressure device 5 is used for compress the shattered foams in the mold bucket 4, and it further comprises a steel plate and a hydraulic cylinder for pushing the steel plate down to compress the shattered foams in the mold bucket 4. The cutting device 6 is used for receiving the high-density foam formed after being compressed by the pressure device 5 and removed from the mold bucket 4, and cuts the high-density foam into a predetermined shape or size.

Thereby, there are following advantages through the above-mentioned steps and system of the present invention:
1. The configuration of the system for manufacturing a high-density foam provided by the present invention is simple and low-cost, and could be rapidly assembled. Further, once the shattered foams are mixed with the glue evenly by the glue spraying device, the system could rapidly make a high-density foam by compressing the shattered foams through the pressure device.
2. The problem of foam scraps could be efficiently solved throughout the steps of the present invention, so as to reduce the scrap foam cut off during the cutting process and the scrap material disposal, thereby properly solving the environmental problem caused by foam wastes and providing the commercial value of utilizability and secondary economic benefit.

An embodiment of the present invention and the technical means applied are as described above. Based on the disclosure or teaching of the description, numerous variations and modifications may be derived, which are to be considered as equivalent changes of the concept of the present invention. Hence, the effectiveness generated by such variations and modifications are within the substantial spirits covered by the description and drawings, and are to be encompassed within the technical scope of the present invention.

In conclusion, based on the above disclosure, the method and system for manufacturing a high-density foam of the present invention are capable of achieving expected objects of the present invention, and provides industrial applicability. Therefore, a patent application is submitted accordingly.

It should be understood that different modifications and variations could be made from the disclosures of the present invention by the people familiar in the art, which should be deemed without departing the spirit of the present invention.

What is claimed is:

1. A method for manufacturing a high-density foam, comprising:
step a: taking a plurality of waste foam scraps with different shapes and sizes and a density of 40-60 g/cm³;
step b: shredding the waste foam scraps into shattered foams;
step c: taking a predetermined weight of the shattered foams and transferring into a mixing drum;
step d: spraying a glue into the mixing drum to mix with the shattered foams inside the mixing drum, wherein the glue at least contains 20-50% alcohol and 20-50% dichloromethane;
step e: stirring for 15-30 minutes and transferring to a mold bucket;
step f: compressing the shattered foams in the mold bucket;
step g: under the condition of 60-100% humidity and room temperature of 10-40 degree C., naturally forming a high-density foam after 90-120 minutes;
step h: removing the high-density foam from the mold bucket and cutting it.

2. The method according to claim 1, wherein the shattered foams in step b is shredded by a shredder.

3. The method according to claim 1, wherein in step f, the shattered foams in the mold bucket are compressed by a steel plate which is lowered by a hydraulic cylinder.

4. A system for manufacturing a high-density foam, comprising:
a shredder for shredding a plurality of waste foam scraps with different shapes and sizes and a density of 40-60 g/cm³ into shattered foams;
a mixing drum connected to the shredder for receiving the shattered foams after shredding;
a glue spraying device for spraying a glue into the mixing drum to mix the shattered foams in the mixing drum with the glue;
a mold bucket connected to the mixing drum for receiving the shattered foams after mixing with the glue evenly;
a pressure device for compress the shattered foams in the mold bucket; and
a cutting device for receiving a high-density foam formed after being compressed by the pressure device and removed from the mold bucket, and cutting the high-density foam into a predetermined shape or size.

5. The system according to claim 4, wherein the shattered foams are weighed and then transferred to the mixing drum.

6. The system according to claim 4, wherein the glue at least contains 20-50% alcohol and 20-50% dichloromethane.

7. The system according to claim 4, wherein the pressure device comprises a steel plate and a hydraulic cylinder for pushing the steel plate down to compress the shattered foams in the mold bucket.
